(19) United States
(12) Patent Application Publication
(10) Pub. No.: US 2007/0051112 A1
(43) Pub. Date: Mar. 8, 2007

(54) TURBO SET WITH STARTING DEVICE

(76) Inventor: Rolf Althaus, Herrliberg (CH)

Correspondence Address: CERMAK & KENEALY LLP, 515 E. BRADDOCK RD, SUITE B, ALEXANDRIA, VA, 22314, US

(21) Appl. No.: 11/279,922

(22) Filed: Apr. 17, 2006

(30) Foreign Application Priority Data
Apr. 18, 2005 (CH) 00688/05

(51) Int. Cl. F02C 7/26

(52) U.S. Cl. 60/786

(57) ABSTRACT

In a turbo set (100) with a starting device (120), the turbo set includes a compressor (102), a combustion chamber (103), and a turbine (104) which are arranged along a flow path of the turbo set. The starting device (120) serves for starting the turbo set and includes a steam generator (121) for the generation of steam which is under overpressure and a supply line (125) for supplying the steam into the flow path (101) of the turbo set (100). In a method for starting the turbo set, the method includes generating steam which is under overpressure and supplying the steam into the flow path of the turbo set.

This application claims priority under 35 U.S.C. §119 to Swiss application number 00688/05, filed 18 Apr. 2005, the entirety of which is incorporated by reference herein.

### BACKGROUND OF THE INVENTION

1. Field of the Invention

The invention relates to a turbo set with a starting device for starting the turbo set. The invention relates, furthermore, to a method for starting the turbo set.

2. Brief Description of the Related Art

The prior art discloses several methods and devices for starting turbo sets, such as, for example, mobile or stationary gas or steam turbine plants or other turbo sets. Particularly in the case of plants which are operated in a stationary way for current generation, the starting of the turbo set demands very stringent requirements from the starting device and the regulation of the starting operation on account of the high powers of the turbo set along with the often very high rotor inertias.

To start a gas turbine plant, for example, an electric motor can be used, which, to start the plant, then has to be connected to the shaft of the compressor, in order thereby to electromotively drive the compressor. The generator is often used as an electric motor for this purpose. The generator is connected to the turbine of the gas turbine plant via a shaft, and the turbine is connected, in turn, to the compressor via this shaft or a further shaft. To start the plant, the generator is activated via a static frequency converter, which is fed with electrical power from the network, and thus functions as an electric motor.

However, the static frequency converters required for this purpose are costly and do not perform any function when the plant has warmed up.

It is therefore, in many instances, more cost-effective to start the gas turbine plant by means of the injection of compressed air. The compressed air required for this purpose originates from a reservoir which has previously been filled by means of an additional compressor or by a branch-off of compressed air when the plant has warmed up.

Such starting of a gas turbine plant by means of the injection of compressed air from an air accumulator is known, for example, from U.S. Pat. No. 4,033,114. In the gas turbine plant described here, the shafts of a high-pressure turbine with a preceding high-pressure combustion chamber and of a low-pressure turbine with a preceding low-pressure combustion chamber are connected to one another. Furthermore, the combustion air is supplied to the high-pressure combustion chamber from the air accumulator. The method for starting the gas turbine plant in this case comprises the following method steps: first, the gas turbine is acted upon with air from the air accumulator in order to reach the operating rotational speed. During the run-up of the gas turbine, the high-pressure combustion chamber is ignited, the inlet temperature into the high-pressure part of the gas turbine being held at a minimum value. Subsequently, with the gas turbine subjected to load, the low-pressure combustion chamber is ignited and the pressure upstream of the high-pressure turbine is increased up to the full operating pressure. In this case, the air quantity flowing through the high-pressure and low-pressure turbines is higher than during continuous operation. The inlet temperature upstream of the low-pressure part of the gas turbine is thereafter increased until the full power of the gas turbine is reached, the inlet temperature upstream of the high-pressure part of the gas turbine subsequently being increased from the minimum value linearly to the full operating temperature. Simultaneously with the increase of the inlet temperature into the high-pressure part, the inlet temperature into the low-pressure part is increased in such a way that the power of the gas turbine remains constant and the air throughput is reduced to a normal value.

U.S. Pat. No. 3,704,586, too, discloses a starting circuit for a gas turbine plant. Here, the gas turbine plant comprises a coal pressure gasifier, an expansion turbine with high-pressure compressor and with an assigned motor generator, a boiler with a connected gas turbine and with a low-pressure compressor coupled to it, and a starting motor. The pressure gasifier is assigned a starting compressed-air accumulator, the starting compressed-air accumulator being connected to the high-pressure compressor and being charged by a part stream of the generated compressed air. The starting compressed-air accumulator is in this case dimensioned such that the compressed air stored in it is sufficient, during the starting of the plant, to start a minimum number of pressure gasifier assemblies by means of compressed air from the compressed-air accumulator. As a result, the turbine, additionally driven motively by the motor generator, and the gas turbine, initially driven by the starting motor, can be brought to power to an extent such that the overall plant can ultimately be operated independently in the idling mode.

The solution of starting a gas turbine plant by means of the injection of compressed air has the disadvantage, however, that a relatively large reservoir has to be made available so that sufficient compressed air can be stored. Particularly in the case of large stationary gas turbine plants, this can be implemented only via very large accumulator volumes which entail relatively high costs in terms of construction. Also, after an operation to start the plant, the reservoir first has to be filled up again before a new starting operation can be carried out. If, for example, an operation to start the plant is discontinued at the first attempt, a second starting attempt usually cannot be carried out immediately thereafter. Particularly for this situation where starting is discontinued, the plant also has to be equipped additionally with a further compressor so that the reservoir can be filled again with the aid of the compressor.

### SUMMARY OF THE INVENTION

The invention is intended to remedy this. One aspect of the present invention includes, therefore, specifying a turbo set with a starting device of the aforementioned type, by means of which disadvantages of the prior art are reduced or avoided. Furthermore, another aspect of the present invention includes a method for starting such a turbo set.

The invention contributes, in particular, to making available a starting device which is cost-effective in relation to the solutions known from the prior art, at the same time with a relatively low space requirement for the starting device. Multiple starts of the turbo set, in each case with only short time intervals between the starting operations, are also to be possible by means of the starting device.

Yet another aspect of the present invention includes a turbo set having a compressor, a combustion chamber and a turbine, the compressor, combustion chamber and turbine being arranged along a flow path of the flow of the turbo set. To start the turbo set, furthermore, a starting device is assigned to the turbo set. The starting device comprises a steam generator for the generation of steam which is under overpressure and also a supply line which at a first end is connected to the steam generator and at a second end issues into the flow path of the turbo set in order to supply the generated steam into the flow path of the turbo set. The supply line is expediently designed to be closeable.

To that extent, the construction of a turbo set embodying principles of the present invention, with a starting device, resembles the turbo sets which are known from the prior art and in which compressed-air injection for the injection of compressed air is provided for starting. However, where the invention is concerned, in order to start the turbo set, steam is supplied into the flow path of the turbo set instead of compressed air and the turbo set is thereby started. The steam required for this purpose is generated in the steam generator at the time of supply or immediately before this. In comparison with the injection of compressed air, this affords the advantage that there is no need for the steam to be supplied to be stored in the gaseous state of aggregation. Before evaporation, the steam is in the liquid state of aggregation and therefore necessitates only a small storage volume. Furthermore, by means of one or even more steam generators, steam can be generated at the starting of the turbo set in sufficient quantity to make it possible, by means of the supply of steam, to start even large turbo sets operated in a stationary way, for example gas or steam turbine plants or even combined-cycle plants operated for current generation. Furthermore, it is possible, without major structural requirements, to design the storage volumes for storing the initial fluid, to be stored in the liquid state of aggregation and required for steam generation, even so as to be sufficiently large to make a multiple repetition of the starting operation at short time intervals possible.

A significant advantage of the solution according to the invention is that even old plants can, in a simple way, be retrofitted, without a high outlay in terms of apparatus, with a starting device in accordance with the present invention. In gas turbines, too, the brief supply of steam for starting the gas turbine presents no problem, since the steam is used only during the starting operation and therefore only briefly at relatively low flow velocities.

The sequence of the operation to start the turbo set after the supply of the steam then corresponds, moreover, to those operations to start turbo sets which are known from the prior art. Consequently, by the steam being supplied, the turbo set is normally run up to a minimum rotational speed at which the combustion chamber can be ignited and from which the turbo set can then be run up further by its own power. After the ignition of the combustion chamber, it may be perfectly expedient to supply steam into the flow path over a further period of time, before the supply line is finally closed and the supply of steam is thus terminated. The turbo group may thereafter be run up further independently or operate at a stationary operating point.

In addition to the supply of steam, however, the rotational speed may also be increased electromotively or the starting operation assisted thereby.

Preferably, the supply line issues, downstream of the compressor, into the flow path of the turbo set.

In an expedient refinement of the invention, the supply line issues into the flow path of the turbo set between the outlet from the compressor and the inlet into the combustion chamber. The supplied steam, after entering the flow path, thus flows first through the combustion chamber and thereafter through the turbine. This leads to an increase in the mass throughput through the combustion chamber, with the result that the combustion chamber can be ignited earlier.

Alternatively or additionally, the supply line expediently issues into the combustion chamber. In this embodiment of the invention, too, the supplied steam flows through the combustion chamber and thus allows an earlier ignition of the combustion chamber. Furthermore, by the steam being supplied directly into the combustion chamber, flow formation in the combustion chamber can also be influenced.

Alternatively or additionally, the supply line issues into the flow path between the outlet from the combustion chamber and the inlet into the turbine. Thus, even during the starting operation, the combustion chamber is supplied with mass air throughput solely via the compressor. When the supply line is being closed, therefore, the mass flow which does not flow or flows only insignificantly through the combustion chamber is reduced, so that the fuel mass flow supplied to the combustion chamber also does not have to be adapted or has to be adapted only slightly.

In an at least two-stage turbine with at least one first turbine stage and one second turbine stage, it may also be expedient, alternatively or additionally, also to cause the supply line to issue into the flow path between the first and the second turbine stages. The supplied steam then expands across the turbine stage or turbine stages arranged downstream of the issue.

In a preferred embodiment of the invention, the steam generator comprises a hydrogen accumulator and an oxygen accumulator and also a burner for the combustion of hydrogen from the hydrogen accumulator with oxygen from the oxygen accumulator. For this purpose, the hydrogen and the oxygen are combined in the burner. Hydrogen reaction then gives rise in the burner to steam from the hydrogen and the oxygen. There is therefore no further combustion byproduct during the hydrogen reaction. Also, in particular, there is no need for further fossil fuel, such as, for example, diesel, or electric energy, for steam generation.

In addition to a low space requirement, a steam generator designed in this way is also considerably less maintenance-intensive than a conventional diesel assembly or conventional auxiliary gas turbine. This ultimately leads to lower maintenance costs, a higher reliability of the steam generator and also, overall, to higher availability.

In terms of apparatus, the arrangement of a static frequency converter for activating a generator motor during the starting phase or even a separate drive motor may be dispensed with, so that, in terms of apparatus, the set-up is, overall, more cost-effective than in the case of plants designed conventionally. Furthermore, the combustion of hydrogen and oxygen in a hydrogen reaction affords the advantage that the pressure level at which the combustion reaction takes place and therefore also the outlet pressure of the generated steam can easily be regulated. Thus, it is possible in a simple way, and, in particular, without requiring a compressor, to ensure that the generated steam has a sufficient overpressure to provide a pressure drop, sufficient for the steam flow, from the steam generator as far as the outlet from the turbo set.

Preferably, the starting device additionally comprises a water injection device for the regulated injection of additional water into the supply line. The water injection device may, for example, comprise a multiplicity of individual nozzles which issue into the supply line. The additionally injected water serves, on the one hand, for cooling the supplied steam. After combustion in the steam generator, the steam initially has a relatively high temperature of, as a rule, about 1200 K-1300 K. A temperature of about 500 K-600 K is normally sufficient for entry into the turbo set. In addition to cooling the steam, the injection of additional water also generates additional steam which either accelerates the starting operation or necessitates a lower generation of steam by the steam generator.

In a further aspect, the invention makes available a method for starting a turbo set. The turbo set comprises a compressor, a combustion chamber and a turbine, the compressor, combustion chamber and turbine being arranged along a flow path. The method according to the invention comprises the method steps of generating steam which is under overpressure and of supplying the steam into the flow path of the turbo set, preferably downstream of the compressor. The advantages of the method according to the invention, as compared with the methods known from the prior art, correspond to the statements made above with respect to the turbo set designed according to the invention.

The sequence of the operation to start the turbo set after the supply of the steam then corresponds, moreover, to those operations to start turbo sets which are known from the prior art. The turbo set is consequently normally run up by means of the supply of steam to a minimum rotational speed from which the turbo set can be run up further by its own power. This means that, to terminate the supply of steam, the turbo set has to be run up to a rotational speed at which the compressor of the turbo set conveys a sufficient mass air throughput to make it possible to carry out an ignition of the combustion chamber. After the ignition of the combustion chamber, the supply of steam may also be continued for a further period of time before supply is terminated by a closing of the supply line. The turbo set is subsequently run up further independently or operated at a stationary operating point.

In addition to the supply of steam, however, the rotational speed may also be increased electromotively or the starting operation thereby assisted.

Expediently, the steam is supplied to the flow path between the compressor outlet and combustion chamber inlet and/or in the combustion chamber and/or between the combustion chamber outlet and turbine inlet and/or, in the case of an at least two-stage turbine, between the turbine stages.

According to a preferred refinement of the method according to the invention, the steam is generated as a result of the combustion of hydrogen with oxygen. For this purpose, hydrogen and oxygen are fed for combustion separately from one another and react with one another in a hydrogen reaction in order to form steam. During the hydrogen reaction, advantageously, no further combustion byproduct occurs. In particular, there is even no need for any further fossil fuel for the generation of steam.

Furthermore, the combustion of hydrogen and oxygen in a hydrogen reaction affords the advantage that the pressure level at which the combustion reaction takes place and therefore also the outlet pressure of the generated steam can easily be regulated. Thus, it is possible in a simple way, and, in particular, without necessitating a compressor, to ensure that the generated steam has a sufficient overpressure to provide a pressure drop sufficient for the steam flow from the steam generator as far as the outlet from the turbo set.

Expediently, water is supplied additionally to the generated steam before the supply of the latter into the flow path of the turbo set. This supply of water serves, on the one hand, for cooling the generated steam and, on the other hand, for increasing the steam quantity.

The method according to the invention is suitable for starting any turbo sets, in particular for starting gas or steam turbine plants or even combined-cycle plants.

### BRIEF DESCRIPTION OF THE DRAWINGS

The invention is explained in more detail below by means of an exemplary embodiment illustrated in the figures in which:

FIG. 1 shows a turbo set known from the prior art, with compressed-air injection;

FIG. 2 shows a turbo set designed according to the invention, with a starting device.

Only the elements and components essential for understanding the invention are illustrated in the figures.

The exemplary embodiment illustrated is to be understood purely instructively and is to serve for better understanding, but not for restricting the subject of the invention.

### DETAILED DESCRIPTION OF EXEMPLARY EMBODIMENTS

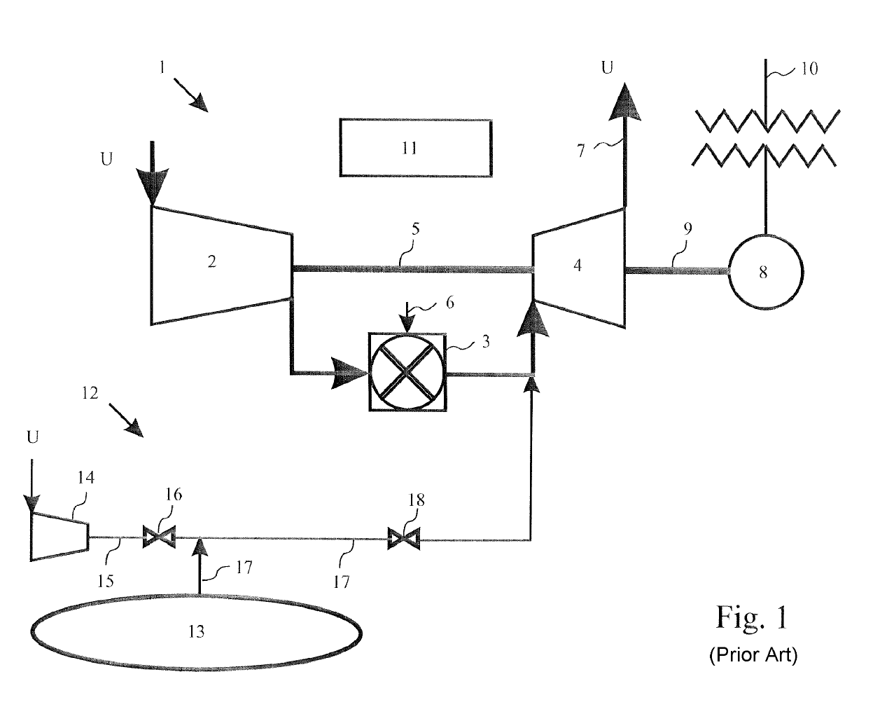

FIG. 1 shows a diagrammatic illustration of a gas turbine plant 1, such as is familiar to a person skilled in the art. The gas turbine plant 1, designed here as a stationary plant, serves for the generation of current. However, in principle, the invention may also be applied to mobile plants or turbo sets used in another way.

The gas turbine plant 1 includes a compressor 2 which sucks in air on the entry side from the surroundings U and compresses this. The compressor 2 is drive-connected fixedly in terms of rotation to a turbine 4 by a shaft 5. In the gas path between the compressor 2 and turbine 4 is arranged a combustion chamber 3 which is fed with fuel for firing via the fuel supply line 6. After passing through the turbine 4, the air/fuel-gas mixture flows into the surroundings U again via an exhaust gas line 7. The turbine 4 is drive-connected to a generator 8 via a further shaft 9. The shafts 5 and 9 may also be produced in one piece. During operation, the gas turbine plant 1 illustrated here delivers a power of about 220 MW which is converted into current via the generator 8 driven by the turbine 4 and is discharged into an electrical network 10 via a current line and a transformer. The gas turbine plant 1 includes, furthermore, a current supply assembly 11 by means of which the gas turbine plant 1 is supplied with current especially during the warm-up phase.

The gas turbine plant 1 may, of course, also be of multiple-shaft design, with a plurality of turbines and intermediately arranged combustion chambers, with a plurality of compressors and intermediately arranged coolers, and the like. These further embodiments are familiar to a person skilled in the art and place the invention merely in a context familiar to a person skilled in the art, which is why there is no further discussion of these at this juncture.

So that the gas turbine plant 1 can be started, the gas turbine plant 1 illustrated in FIG. 1 includes, furthermore, a compressed-air injection device 12 as a starting device for starting the gas turbine plant. The compressed-air injection device 12 includes a reservoir 13 which is filled with compressed air by a compressor 14 via the filling line 15. The filling line 15 can be closed by means of a throttle slide 16 integrated into the filling line. The compressed-air injection device 12 includes, furthermore, a connecting line 17 which can likewise be closed by means of a throttle slide 18 integrated into the connecting line 17. One end of the connecting line 17 is connected to the reservoir 13. The other end of the connecting line 17 issues into the flow path of the gas turbine plant 1 between the combustion chamber 3 and the turbine 4. To start the gas turbine plant 1, the throttle slide 18 is opened, so that compressed air flows out of the reservoir 13 into the turbine 4 via the connecting line 17. The compressed air introduced into the gas turbine plant via the connecting line 17 then expands across the turbine 4, with the result that the turbine 4 is set in rotation. Via the shaft 5, the compressor 2 is driven, which thereby sucks in air from the surroundings U and compresses this. Beyond a certain compressor rotational speed, the mass air flow delivered to the combustion chamber 3 by the compressor 2 is sufficient to make it possible to ignite the combustion chamber 3. In the example illustrated here, this minimum rotational speed of the compressor lies at a power output of about 15 MW of the gas turbine plant 1. After the ignition of the combustion chamber 3, this is usually followed by a stabilization phase, before the injection of compressed air into the gas turbine plant is terminated. The rotational speed of the plant may then, as required, be further increased independently by means of an increase in the fuel quantity supplied.

Since the compressed air required for starting the gas turbine plant 1 cannot be generated in sufficient quantity at the time of the starting operation, the compressed air must be made available in the reservoir 13 even before the injection operation is started. This normally takes place by means of the compressor 14 or by a branch-off of compressed air from the gas turbine plant 1 itself. Such a branch-off of compressed air may, of course, be carried out only during the operation of the plant, that is to say during the operation of the plant in each case only for a later starting operation.

By contrast, the arrangement of an additional compressor 14 for filling the reservoir 13 incurs high costs for the procurement and operation of the compressor 14. Such a compressor also has no function for a predominant part of the operating period of the gas turbine plant 1. By contrast, if the reservoir 13 is filled by compressed air being branched off during the operation of the gas turbine plant, then at least a first filling of the reservoir 13 must take place with the aid of an additional compressor. Also, for example after a discontinued operation to start the gas turbine plant 1, it may be necessary to fill up the reservoir again, since the compressed air quantity which has still remained in the reservoir is no longer sufficient for a second starting operation. As in the very first starting operation, too, in these cases a filling of the reservoir by means of an additional compressor is required.

A further serious disadvantage is the relatively large structural volume for the reservoir 13. Since a sufficient compressed air quantity must be stored in the reservoir in order to run up the gas turbine to about one tenth of the power of the gas turbine at the design point, reservoirs with large volumes of several hundred cubic meters normally have to be provided. In the plant described in U.S. Pat. No. 3,704,586, the reservoir designated by 12 includes 400 cubic meters with an operating pressure of 36 bar. Such large pressure-resistant volumes require structurally complicated measures and thereby increase the costs of such a plant. The construction volume required for the reservoir also cannot be utilized in any other way.

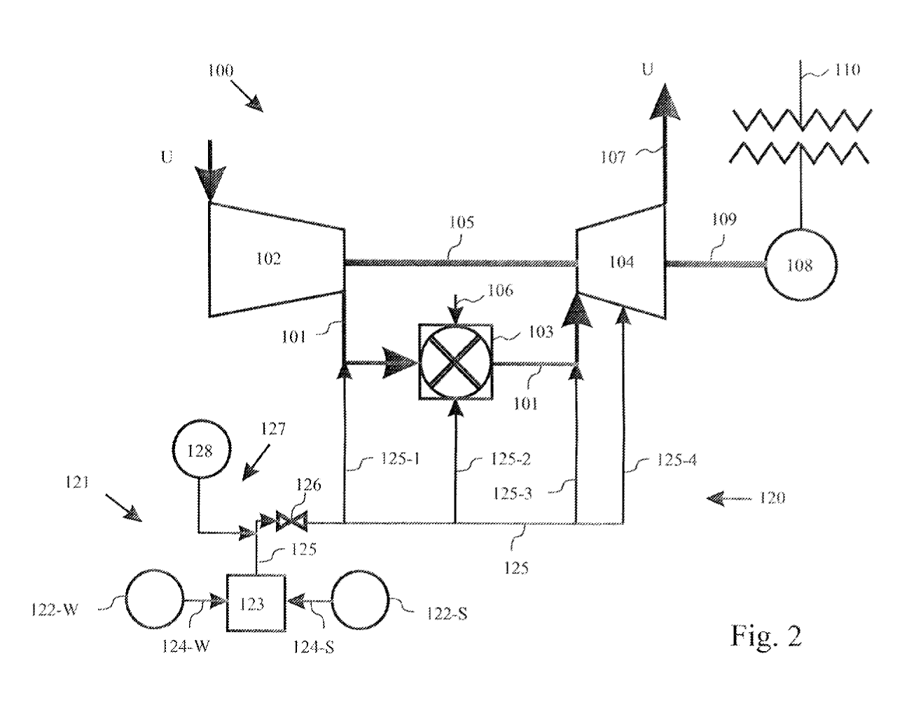

This is where the invention comes in. FIG. 2 shows a turbo set 100 designed according to the invention, with starting device. The turbo set illustrated may be, for example, part of an energy generation plant, such as, for example, of a gas turbine plant or of a combined gas and steam power plant.

The turbo set 100 illustrated in FIG. 2 includes a multistage compressor 102, a combustion chamber 103 with fuel supply line 106 and a two-stage turbine 104 together with exhaust gas line 107. The compressor 102, combustion chamber 103 and turbine 104 are arranged along the flow path 101 of the turbo set. Furthermore, the compressor 102 and the turbine 104 are drive-connected fixedly in terms of rotation to one another via a shaft 105. The turbo set includes, furthermore, a generator 108 which is drive-connected to the turbine 104 via a shaft 109. During the operation of the turbo set 100, the generator 108 generates current which is fed into an external network 110.

To start the turbo set 100, a starting device 120 is assigned, furthermore, to the turbo set. The starting device 120 includes a steam generator 121 for generating steam which is under overpressure, and also a closeable supply line 125 for supplying the generated steam into the flow path 101 of the turbo set 100. For this purpose, the supply line 125 is connected at its first end to the steam generator 121. At the second end, the supply line 125 fans out into, overall, four part lines 125-1, 125-2, 125-3 and 125-4, each of which issues into the flow path 101 of the turbo set 100 at another issue point. Thus, the first part line 125-1 issues into the flow path 101 between the outlet from the compressor 102 and the inlet into the combustion chamber 103. The second part line 125-2 issues into the flow path 101 directly in the combustion chamber 103. The third part line 125-3 issues into the flow path 101 between the outlet from the combustion chamber 103 and the inlet into the turbine 104, and the fourth part line 125-4 issues into the flow path 101 between the first and the second turbine stages. By means of throttle slides for throughflow regulation, which are not illustrated in FIG. 2, the apportionment of the steam supplied in the supply line 125 to the four part lines 125-1, 125-2, 125-3 and 125-4 can be set. This apportionment may also be varied during the starting operation.

Furthermore, the supply line 125 has integrated into a throttle slide 126 which is expediently activated by a central regulating device (not illustrated in FIG. 2). In the case of a turbo set at rest and also in the case of a turbo set which is run up, the throttle slide 126 is closed completely. The throttle slide 126 is therefore opened only during the starting of the turbo set 100, in order to cause the steam generated in the steam generator 121 to flow into the flow path 101 of the turbo set 100 via the supply line 125 and the part lines 125-1, 125-2, 125-3 and 125-4.

The steam generator 121 illustrated in FIG. 2 includes a hydrogen accumulator 122-W and an oxygen accumulator 122-S and also a burner 123 for the combustion of hydrogen from the hydrogen accumulator 122-W with oxygen from the oxygen accumulator 122-S. For this purpose, the burner 123 is connected to the accumulators 122-W and 122-S via the supply lines 124-W and 124-S. The hydrogen accumulator 122-W and the oxygen accumulator 122-S are designed as liquid-gas accumulators. Hydrogen and oxygen are thus present in the accumulators in liquid form and under high pressure. Due to the fact that the hydrogen and the oxygen are stored in liquid form, a considerably smaller storage volume is required for storing a specific molar quantity of hydrogen and oxygen than would be necessary if this molar quantity of compressed air or gaseous steam were to be stored. Moreover, water has a high expansion rate during evaporation.

To start the turbo set 100, hydrogen and oxygen are extracted, as required, from the accumulators 122-W and 122-S, are introduced into the burner 123 and are burnt there in a hydrogen reaction to form steam. The introduction of hydrogen and oxygen into the burner is controlled by means of the throttling and regulating elements which are not illustrated in FIG. 2, but are familiar to a person skilled in the art.

The hydrogen reaction takes place highly exothermally, so that the steam emerging from the burner 123 has a very high temperature of about 1200 K-1300 K. In order, on the one hand, to cool the temperature of the steam to a lower temperature of about 500 K-700 K and, on the other hand, additionally to increase the quantity of steam provided, the starting device 120 includes, furthermore, a water injection device 127 for the regulated injection of additional water from a water reservoir 128 into the supply line 125. By means of the water injection device 127, a regulated quantity of demineralized water is admixed to the steam coming from the burner 123 and at the same time evaporates. The regulating device used for quantity regulation and the required throttle slides for regulating the supplied water quantity are not illustrated in FIG. 2. However, these are familiar to a person skilled in the art.

After the admixing of additional water, the steam located in the supply line 125 has a temperature of about 500 K-700 K.

To start the turbo set 100, therefore, first, hydrogen which is under overpressure and oxygen which is under overpressure are extracted from the accumulators 122-W and 122-S and are introduced into the burner 123, where the hydrogen is burnt with the oxygen to form steam. Water from the reservoir 128 is admixed in the supply line 125 to the steam coming from the burner 123, and the steam quantity is thereby increased. The steam thus generated, which is under overpressure, is fed into the flow path 101 of the turbo set 100 via the supply line 125 and the part lines 125-1, 125-2, 125-3 and 125-4. At the commencement of the starting operation and in the lower rotational speed range of the turbo set 100, the predominant part of the steam quantity or even the entire steam quantity is preferably fed into the flow path 101 via the third or the fourth part line 125-3 and 125-4. The steam quantity thus fed in expands across the turbine 104, with the result that the turbine 104 is driven. In the medium and upper rotational speed ranges of the starting operation, there is then a successive changeover to a supply of the steam quantity also via the first and the second part lines 125-1 and 125-2. This affords the advantage that the steam quantity supplied by the first and the second part lines 125-1 and 125-2 is not expanded directly across the turbine 104, but, instead, flows previously through the combustion chamber 103. The combustion chamber flow is thus composed of the air quantity which is conveyed by the compressor and of the steam quantity which is supplied via the first and the second part lines 125-1 and 125-2. The overall mass throughput flowing through the combustion chamber 103 is thus higher than only the mass air throughput conveyed by the compressor. Accordingly, an ignition or even a stepped ignition of the combustion chamber 103 can take place earlier than without the supply of at least part of the steam by the first part line 125-1 or the second part line 125-2. As a result of an earlier ignition of the combustion chamber 103, the starting duration of the turbo set 100 can, overall, be reduced.

The turbo set 100 illustrated in FIG. 2 and the method described for starting the turbo set 100 constitute merely exemplary embodiments of the invention which can certainly be modified in many different ways by a person skilled in the art, without departing from the idea of the invention. Thus, for example, the turbo set may additionally include a drive motor which is connected to the turbine shaft in order to start the turbo set. The generator illustrated in FIG. 2 may likewise also be wired up as a drive motor from a static frequency converter. The turbo set can then be started by means of a combined steam supply and electromotive drive. The operation to start the turbo set can thereby take place in a more flexible way. The turbo set thus driven can also be brought to a higher rotational speed during the starting operation, without the combustion chamber having to be ignited. Alternatively, in this case, the steam generator could also have a smaller and more cost-effective dimensioning, in order to make it possible for the turbo set to be started at a starting rotational speed which continues to be the same.

However, a combination of the starting device according to the invention or of the starting method according to the invention with other starting devices and starting methods known from the prior art is likewise also possible.

### LIST OF REFERENCE SYMBOLS

U Surroundings
1 Gas turbine plant
2 Compressor
3 Combustion chamber
4 Turbine
5 Shaft between compressor and turbine
6 Fuel supply line
7 Exhaust gas line
8 Generator
9 Shaft between turbine and generator
10 Network
11 Current supply assembly
12 Compressed-air injection device
13 Reservoir
14 Compressor
15 Filling line
16 Throttle slide
17 Connecting line
18 Throttle slide
100 Turbo set designed according to the invention, with starting device
101 Flow path of the turbo set
102 Compressor
103 Combustion chamber
104 Turbine
105 Shaft between compressor and turbine
106 Fuel supply line
107 Exhaust gas line
108 Generator
109 Shaft between turbine and generator
110 Network
120 Starting device
121 Steam generator
122-W Hydrogen accumulator
122-S Oxygen accumulator
123 Burner
124-W, 124-S Supply lines
125 Supply line
125-1, 125-2 Part lines
125-3, 125-4 Part lines
126 Throttle slide
127 Water injection device
128 Water reservoir

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A turbo set comprising:
a compressor;
a combustion chamber;
a turbine;
wherein the compressor, combustion chamber, and turbine are arranged along a flow path; and
a starting device configured and arranged to start the turbo set, the starting device comprising a steam generator configured and arranged to generate overpressurized steam, and a supply line having a first end connected to the steam generator and a second end which issues into the flow path.

2. The turbo set as claimed in claim 1, wherein the supply line issues into the flow path of the turbo set downstream of the compressor.

3. The turbo set as claimed in claim 2, wherein the compressor comprises an outlet and the combustion chamber comprises an inlet, and wherein the supply line issues into the flow path between compressor outlet and the combustion chamber inlet.

4. The turbo set as claimed in claim 2, wherein the supply line issues into the combustion chamber.

5. The turbo set as claimed in claim 2, wherein the combustion chamber comprises an outlet and the turbine comprises an inlet, and wherein the supply line issues into the flow path between the combustion chamber outlet and the turbine inlet.

6. The turbo set as claimed in claim 2, wherein the turbine comprises at least one first turbine stage and at least one second turbine stage, and wherein the supply line issues into the flow path between the at least one first turbine stage and the at least one second turbine stage.

7. The turbo set as claimed in claim 1, wherein the steam generator comprises a hydrogen accumulator, an oxygen accumulator, and a burner configured and arranged for combustion of hydrogen from the hydrogen accumulator with oxygen from the oxygen accumulator.

8. The turbo set as claimed in claim 7, wherein the starting device additionally comprises a water injection device configured and arranged to regulatedly inject additional water into the supply line.

9. The turbo set as claimed in claim 1, wherein the supply line comprises a closing device.

10. A method for starting a turbo set having a compressor, a combustion chamber, and a turbine, the compressor, combustion chamber, and turbine being arranged along a flow path, the method comprising:
generating overpressurized steam; and
supplying the steam into the flow path of the turbo set downstream of the compressor.

11. The method as claimed in claim 10, wherein generating steam comprises combusting hydrogen with oxygen.

12. The method as claimed in claim 10, further comprising:
supplying additional water to the steam before said supplying steam into the flow path of the turbo set.
